(19) United States
(12) Patent Application Publication
(10) Pub. No.: US 2025/0274926 A1
(43) Pub. Date: Aug. 28, 2025

(54) MESSAGE TRANSMISSION BASED ON BANDWIDTH SUPPORTED BY USER DEVICE

(71) Applicant: Nokia Technologies Oy, Espoo (FI)

(72) Inventors: Ahlem KHLASS, Massy (FR); Jussi-Pekka KOSKINEN, Oulu (FI); Samuli Heikki TURTINEN, Oulu (FI)

(21) Appl. No.: 18/866,438

(22) PCT Filed: May 25, 2022
(86) PCT No.: PCT/EP2022/064265

§ 371 Date: Nov. 15, 2024

(51) Int. Cl. H04W 72/0457; H04W 24/08; H04W 68/02

(52) U.S. Cl. CPC H04W 72/0457; H04W 24/08; H04W 68/02

(57) ABSTRACT

Disclosed is a method comprising receiving information indicating a bandwidth supported by a user device; and transmitting, to the user device, a message based on the bandwidth supported by the user device.

### FIELD

The following example embodiments relate to wireless communication.

### BACKGROUND

Paging is a mechanism used to initiate communication services for user devices that are in idle or inactive state. As new types of user devices are being developed, it is desirable to improve the paging mechanism to support these new types of user devices.

### BRIEF DESCRIPTION

The scope of protection sought for various example embodiments is set out by the independent claims. The example embodiments and features, if any, described in this specification that do not fall under the scope of the independent claims are to be interpreted as examples useful for understanding various embodiments.

According to an aspect, there is provided an apparatus comprising at least one processor, and at least one memory including computer program code, wherein the at least one memory and the computer program code are configured, with the at least one processor, to cause the apparatus to: receive information indicating a bandwidth supported by a user device; and transmit, to the user device, a message based on the bandwidth supported by the user device.

According to another aspect, there is provided an apparatus comprising means for: receiving information indicating a bandwidth supported by a user device; and transmitting, to the user device, a message based on the bandwidth supported by the user device.

According to another aspect, there is provided a method comprising: receiving information indicating a bandwidth supported by a user device; and transmitting, to the user device, a message based on the bandwidth supported by the user device.

According to another aspect, there is provided a computer program comprising instructions which, when executed by an apparatus, cause the apparatus to perform at least the following: receiving information indicating a bandwidth supported by a user device; and transmitting, to the user device, a message based on the bandwidth supported by the user device.

According to another aspect, there is provided a computer program comprising instructions for causing an apparatus to perform at least the following: receiving information indicating a bandwidth supported by a user device; and transmitting, to the user device, a message based on the bandwidth supported by the user device.

According to another aspect, there is provided a computer readable medium comprising program instructions for causing an apparatus to perform at least the following: receiving information indicating a bandwidth supported by a user device; and transmitting, to the user device, a message based on the bandwidth supported by the user device.

According to another aspect, there is provided a non-transitory computer readable medium comprising program instructions for causing an apparatus to perform at least the following: receiving information indicating a bandwidth supported by a user device; and transmitting, to the user device, a message based on the bandwidth supported by the user device.

According to another aspect, there is provided an apparatus comprising at least one processor, and at least one memory including computer program code, wherein the at least one memory and the computer program code are configured, with the at least one processor, to cause the apparatus to: receive information indicating a bandwidth to be used for receiving a message; monitor for the message on the indicated bandwidth; and receive the message on the indicated bandwidth during the monitoring.

According to another aspect, there is provided an apparatus comprising means for: receiving information indicating a bandwidth to be used for receiving a message; monitoring for the message on the indicated bandwidth; and receiving the message on the indicated bandwidth during the monitoring.

According to another aspect, there is provided a method comprising: receiving information indicating a bandwidth to be used for receiving a message; monitoring for the message on the indicated bandwidth; and receiving the message on the indicated bandwidth during the monitoring.

According to another aspect, there is provided a computer program comprising instructions which, when executed by an apparatus, cause the apparatus to perform at least the following: receiving information indicating a bandwidth to be used for receiving a message; monitoring for the message on the indicated bandwidth; and receiving the message on the indicated bandwidth during the monitoring.

According to another aspect, there is provided a computer program comprising instructions for causing an apparatus to perform at least the following: receiving information indicating a bandwidth to be used for receiving a message; monitoring for the message on the indicated bandwidth; and receiving the message on the indicated bandwidth during the monitoring.

According to another aspect, there is provided a computer readable medium comprising program instructions for causing an apparatus to perform at least the following: receiving information indicating a bandwidth to be used for receiving a message; monitoring for the message on the indicated bandwidth; and receiving the message on the indicated bandwidth during the monitoring.

According to another aspect, there is provided a non-transitory computer readable medium comprising program instructions for causing an apparatus to perform at least the following: receiving information indicating a bandwidth to be used for receiving a message; monitoring for the message on the indicated bandwidth; and receiving the message on the indicated bandwidth during the monitoring.

### LIST OF DRAWINGS

In the following, various example embodiments will be described in greater detail with reference to the accompanying drawings, in which

FIG. 1 illustrates an example embodiment of a cellular communication network;

FIG. 2 illustrates a flow chart according to an example embodiment;

FIG. 3 illustrates a flow chart according to an example embodiment;

FIG. 4 illustrates a flow chart according to an example embodiment;

FIG. 5 illustrates a signaling diagram according to an example embodiment;

FIG. 6 illustrates a signaling diagram according to an example embodiment;

FIG. 7 illustrates a signaling diagram according to an example embodiment;

FIG. 8 illustrates an example embodiment of an apparatus; and

FIG. 9 illustrates an example embodiment of an apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different example embodiments will be described using, as an example of an access architecture to which the example embodiments may be applied, a radio access architecture based on long term evolution advanced (LTE Advanced, LTE-A), new radio (NR, 5G), beyond 5G, or sixth generation (6G) without restricting the example embodiments to such an architecture, however. It is obvious for a person skilled in the art that the example embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

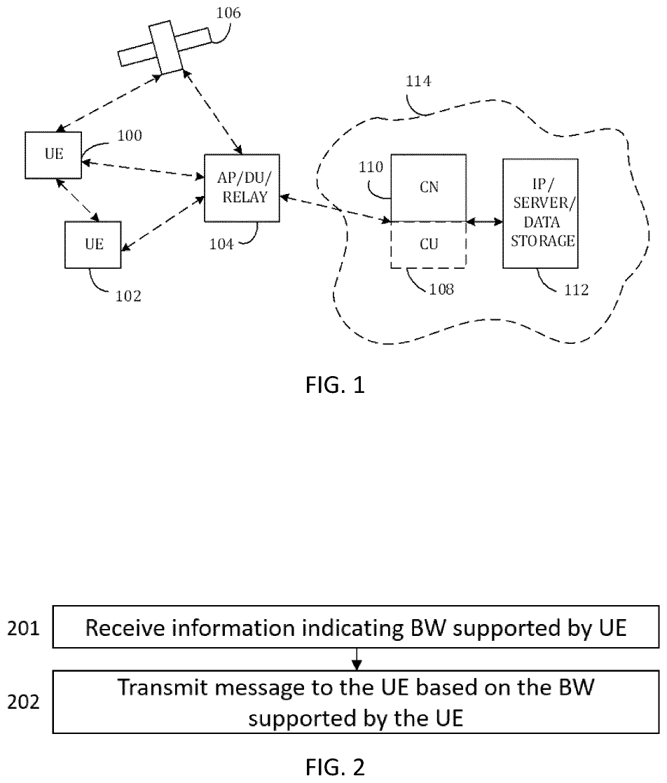

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The example embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a radio cell with an access node 104, such as an evolved Node B (abbreviated as eNB or eNodeB) or a next generation Node B (abbreviated as gNB or gNodeB), providing the radio cell. The physical link from a user device to an access node may be called uplink (UL) or reverse link, and the physical link from the access node to the user device may be called downlink (DL) or forward link. A user device may also communicate directly with another user device via sidelink (SL) communication. It should be appreciated that access nodes or their functionalities may be implemented by using any node, host, server or access point etc. entity suitable for such a usage.

A communication system may comprise more than one access node, in which case the access nodes may also be configured to communicate with one another over links, wired or wireless, designed for the purpose. These links may be used for signaling purposes. The access node may be a computing device configured to control the radio resources of communication system it is coupled to. The access node may also be referred to as a base station, a base transceiver station (BTS), an access point or any other type of interfacing device including a relay station capable of operating in a wireless environment. The access node may include or be coupled to transceivers. From the transceivers of the access node, a connection may be provided to an antenna unit that establishes bi-directional radio links to user devices. The antenna unit may comprise a plurality of antennas or antenna elements. The access node may further be connected to a core network 110 (CN or next generation core NGC). Depending on the system, the counterpart on the CN side may be a serving gateway (S-GW, routing and forwarding user data packets), packet data network gateway (P-GW) for providing connectivity of user devices to external packet data networks, user plane function (UPF), mobility management entity (MME), access and mobility management function (AMF), or location management function (LMF), etc.

The user device illustrates one type of an apparatus to which resources on the air interface may be allocated and assigned, and thus any feature described herein with a user device may be implemented with a corresponding apparatus, such as a relay node.

An example of such a relay node may be a layer 3 relay (self-backhauling relay) towards the access node. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and user device(s), and/or between the IAB node and other IAB nodes (multi-hop scenario).

Another example of such a relay node may be a layer 1 relay called a repeater. The repeater may amplify a signal received from an access node and forward it to a user device, and/or amplify a signal received from the user device and forward it to the access node.

The user device may also be called a subscriber unit, mobile station, remote terminal, access terminal, user terminal, terminal device, or user equipment (UE) just to mention but a few names or apparatuses. The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable or wearable device with radio parts (such as a watch, earphones or eyeglasses) and the computation may be carried out in the cloud. The user device (or in some example embodiments a layer 3 relay node) may be configured to perform one or more of user equipment functionalities. The user device may also comprise, or be comprised in, a robot or a vehicle such as a train or a car.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented. 5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may have multiple radio interfaces, namely below 6 GHz, cmWave and mmWave, and also being integrable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave-mmWave). One of the concepts considered to be used in 5G networks may be network slicing, in which multiple independent and dedicated virtual sub-networks (network instances) may be created within the substantially same infrastructure to run services that have different requirements on latency, reliability, throughput and mobility. The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head (RRH) or a radio unit (RU), or an access node comprising radio parts. It may also be possible that node operations are distributed among a plurality of servers, nodes or hosts. Carrying out the RAN real-time functions at the RAN side (in a distributed unit, DU 104) and non-real time functions in a centralized manner (in a central unit, CU 108) may be enabled for example by application of cloudRAN architecture.

It should also be understood that the distribution of labour between core network operations and access node operations may differ from that of the LTE or even be non-existent. Some other technology advancements that may be used include big data and all-IP, which may change the way networks are being constructed and managed. 5G (or new radio, NR) networks may be designed to support multiple hierarchies, where MEC servers may be placed between the core and the access node. It should be appreciated that MEC may be applied in 4G networks as well.

5G may also utilize non-terrestrial communication, for example satellite communication, to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). At least one satellite 106 in the mega-constellation may cover several satellite-enabled network entities that create on-ground cells. The on-ground cells may be created through an on-ground relay node 104 or by a gNB located on-ground or in a satellite.

6G networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G may include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

It is obvious for a person skilled in the art that the depicted system is only an example of a part of a radio access system and in practice, the system may comprise a plurality of access nodes, the user device may have an access to a plurality of radio cells and the system may also comprise other apparatuses, such as physical layer relay nodes or other network elements, etc. At least one of the access nodes may be a Home eNodeB or a Home gNodeB.

Furthermore, the access node may also be split into: a radio unit (RU) comprising a radio transceiver (TRX), i.e., a transmitter (Tx) and a receiver (Rx); one or more distributed units (DUs) that may be used for the so-called Layer 1 (L1) processing and real-time Layer 2 (L2) processing; and a central unit (CU) (also known as a centralized unit) that may be used for non-real-time L2 and Layer 3 (L3) processing. The CU may be connected to the one or more DUs for example by using an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU may be defined as a logical node hosting higher layer protocols, such as radio resource control (RRC), service data adaptation protocol (SDAP) and/or packet data convergence protocol (PDCP), of the access node. The DU may be defined as a logical node hosting radio link control (RLC), medium access control (MAC) and/or physical (PHY) layers of the access node. The operation of the DU may be at least partly controlled by the CU. The CU may comprise a control plane (CU-CP), which may be defined as a logical node hosting the RRC and the control plane part of the PDCP protocol of the CU for the access node. The CU may further comprise a user plane (CU-UP), which may be defined as a logical node hosting the user plane part of the PDCP protocol and the SDAP protocol of the CU for the access node.

Cloud computing platforms may also be used to run the CU and/or DU. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of labour between the above-mentioned access node units, or different core network operations and access node operations, may differ.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The access node(s) of FIG. 1 may provide any kind of these cells. A cellular radio system may be implemented as a multilayer network including several kinds of radio cells. In multilayer networks, one access node may provide one kind of a radio cell or radio cells, and thus a plurality of access nodes may be needed to provide such a network structure.

For fulfilling the need for improving the deployment and performance of communication systems, the concept of “plug-and-play” access nodes may be introduced. A network which may be able to use “plug-and-play” access nodes, may include, in addition to Home eNodeBs or Home gNodeBs, a Home Node B gateway, or HNB-GW (not shown in FIG. 1). An HNB-GW, which may be installed within an operator's network, may aggregate traffic from a large number of Home eNodeBs or Home gNodeBs back to a core network.

An RRC idle or inactive state may be used to reduce UE power consumption, and thus conserve the battery power of the UE. If the UE is in RRC connected state and it has no data to send or receive, then the access node may wait for a specific timer (UE inactivity timer), and once that timer expires, the access node may switch the UE to idle or inactive state. This may be done by sending a RRC release message to the UE.

Paging is a mechanism used to initiate communication services for UEs that are in RRC idle state or RRC inactive state. For example, the network may transmit a paging message to a UE in idle or inactive state in order to switch the UE to connected state, when the network needs to transmit downlink data to the UE. Paging may also be used by the network for other purposes, such as triggering the UE to acquire a system information update, for indicating the availability of a tracking reference signal (TRS) to the UE, and/or for providing an earthquake and tsunami warning system (ETWS) notification to the UE via short messages. Both paging messages and short messages may be addressed with paging radio network temporary identifier (P-RNTI) on physical downlink control channel (PDCCH), but while paging messages are sent on paging control channel (PCCH), short messages are sent over PDCCH directly.

The UE may occasionally wake up to monitor whether the network is sending any paging message to it, but the UE has to spend some energy (battery power) to run this monitoring process on those time occasions. In RRC idle state, the UE monitors the paging channels for paging initiated by the core network (CN). In RRC inactive state, the UE also monitors the paging channels for RAN-initiated paging. However, the UE does not need to monitor the paging channels continuously. The UE can conserve its battery power by sleeping during the time when the network is not transmitting paging messages (instead of continuously monitoring for the paging messages).

This kind of reception mechanism may be referred to as discontinuous reception (DRX). During the idle or inactive state, the UE stays in sleep mode according to a DRX cycle, which may also be referred to as a paging cycle. The UE (in RRC idle or inactive state) wakes up and monitors the paging channels during at least one paging occasion (PO) per paging cycle. The network may indicate a default paging cycle to the UE in system information. As a non-limiting example, the default paging cycle may be 320 ms, 640 ms, 1280 ms, or 2560 ms. The UE may determine its paging cycle based on the shortest of the UE-specific DRX value(s) (if configured by RRC and/or upper layers) and/or the default paging cycle (default DRX value) broadcast in system information. In RRC idle state, if a UE-specific DRX value is not configured by the upper layers, the default DRX value may be applied. As a non-limiting example, if the paging cycle is set to 1280 ms (128 radio frames), then the UE may wake up in frame #3, then again in frame #131 (after 128 frames), and then again in frame #259, and so on. The radio frame in which the UE wakes up is called a paging frame (PF). Within a radio frame, there may be 10 subframes. However, the UE may not remain awake in all 10 subframes of the paging frame. Instead, the UE may wake up in a specific subframe, for example subframe 0, 4, 5 or 9, within the paging frame. These specific subframe(s) within a paging frame, when the UE wakes up, are called paging occasions. The POs for CN-initiated and RAN-initiated paging may be based on the same UE ID, resulting in overlapping POs for both.

The number of different POs in a paging cycle is configurable via system information, and the network may distribute UEs to those POs based on their IDs. The system information may comprise a parameter NB, which defines the number of paging subframes within the paging cycle. The UE may determine the paging frame based on the paging cycle, the parameter NB, and the UE ID. The UE ID may be based on the international mobile subscriber identity (IMSI) value of the UE. Once the UE has determined the paging frame, it may determine the subframe of the paging frame to wake up on.

Thus, the UE periodically wakes up according to the paging cycle and monitors PDCCH for the paging downlink control information (DCI) in order to check for the presence of a paging message on physical downlink shared channel (PDSCH). The paging DCI comprises the time-frequency allocation of the paging message on the PDSCH. If there is no allocation, the UE determines that it is not paged. If the PDCCH indicates that a paging message is transmitted in the subframe (i.e., if there is an allocation), then the UE proceeds with receiving the paging message on the PDSCH, and demodulates the paging channel (PCH) to see if the paging message is directed to it (the paging message might not be addressed to this specific UE, since there may be multiple UEs using the same paging cycle). If the UE finds its own ID in the paging message, it considers itself paged and may take appropriate action (e.g., sets up an RRC connection).

The network may transmit a paging early indication (PEI) or a wake-up signal (WUS) to the UE before the paging occasion of the UE. The PEI or WUS may be used to indicate to the UE whether or not there is a paging message coming for the UE on the paging occasion. Thus, the PEI or WUS indicates whether or not the UE shall monitor for a paging message. If there is no paging message coming, then the UE may skip procedures related to time-frequency synchronization, which may otherwise be needed to decode the PDSCH carrying the paging message. The PEI may be carried in PDCCH.

The PEI may divide the UEs into subgroups to further reduce the paging probability. For example, for UE subgroups indication in the physical layer, up to 8 subgroups per paging occasion may currently be supported (it should be appreciated that this number may change in the future). In other words, the PEI may indicate whether the UE should monitor a paging occasion, if the UE's group or subgroup is paged. The UE may not be required to monitor a certain paging occasion, if the UE does not detect a PEI on the PEI occasion(s) for the paging occasion. A PEI occasion (PEI-O) may also be referred to as a PEI monitoring occasion (MO).

The PEI may also carry non-paging-related information, such as an ETWS notification, system information update indication, and/or a TRS availability indication. After determining the PEI occasion, the UE may also check for these information bits in addition to whether it will be paged in the corresponding paging occasion.

The identification of PEI occasion(s) before a paging occasion may be achieved by using a configurable PEI detection time window and time offsets. For a target paging occasion, a PEI occasion may be defined as a set of PDCCH monitoring occasions associated with the transmitted synchronization signal blocks (SSBs). The reference PEI frame (PEI-F) start may be subject to a PEI offset before the paging frame of the paging occasion. In other words, the PEI may be placed before the paging occasion.

The PEI occasion may be determined based on an offset (time gap) to the paging frame of the paging occasion. The paging occasions are located in reference to the paging frame, and therefore the PEI occasion may be referenced to the same paging frame. For example, there may be up to four paging occasions per paging frame. It may also be possible to provide a separate offset for each paging frame, thus enabling to point different paging frames to the same PEI occasion, and thereby sharing the PEI (e.g., there may be a first offset value for a first paging frame and a second offset value for a second paging frame).

Reduced capability (RedCap) devices may have lower complexity (e.g., reduced bandwidth and number of antennas), a longer battery life, and a smaller form factor than non-RedCap devices, such as enhanced mobile broadband (eMBB) and ultra-reliable low latency communication (URLLC) devices. For example, a RedCap device may comprise 1 receiver branch and 1 transmitter branch (1RX/1TX), or 2 receiver branches and 1 transmitter branch (2RX/1TX), in both frequency range 1 (FR1) and frequency range 2 (FR2). RedCap devices may support all FR1 and FR2 bands for frequency-division duplexing (FDD) and time-division duplexing (TDD). Some examples of RedCap devices include (but are not limited to) industrial wireless sensors, video surveillance cameras, and wearables (e.g., smart watches, rings, eHealth-related devices, personal protection equipment, medical monitoring devices, etc.). RedCap devices may also be referred to as NR-Lite devices or NR-Light devices.

NR Release 17 RedCap devices may support a bandwidth of 20 MHz in FR1. To further reduce the complexity of RedCap devices, the bandwidth of NR Release 18 RedCap devices may be reduced to 5 MHz in FR1.

However, currently there may be no means for an access node to determine whether the paged UE is a RedCap device or not, and whether the paged UE supports 5 MHz bandwidth or 20 MHz bandwidth. In this case, the access node may need to transmit the paging message on the initial bandwidth part (BWP) that is supported by all UEs (e.g., RedCap devices with limited bandwidth and legacy UEs that support wide bandwidth).

Some example embodiments may provide an improved paging mechanism for bandwidth-limited UEs, where the access node is able to use the UE bandwidth information for example for paging message transmission on a bandwidth supported by the UE. By knowing the UE bandwidth information, the access node can configure the UE with a specific paging configuration and page the UE on the bandwidth supported by the UE.

Some example embodiments are described below using principles and terminology of 5G technology without limiting the example embodiments to 5G communication systems, however.

FIG. 2 illustrates a flow chart according to an example embodiment of a method performed by an apparatus such as, or comprising, or comprised in, an access node of a radio access network. The access node may correspond to the access node 104 of FIG. 1.

Referring to FIG. 2, in block 201, information indicating a bandwidth (BW) supported by a user device is received. The bandwidth may be indicated as a value. The indicated bandwidth value may be smaller than or equal to the maximum bandwidth supported by the user device. The information may be received, for example, from the user device, from another access node, or from a core network entity such as an access and mobility management function (AMF). The other access node may be, for example, a source gNB, an anchor gNB, or a last-serving gNB (e.g., gNB where the UE context is located while in RRC_inactive state), which may provide the information to the other gNB(s) where the user device is going to be paged. The user device may be a reduced capability device or any other type of user device that supports limited bandwidth.

Herein the term “bandwidth” may refer to signal bandwidth measured in hertz. As a non-limiting example, the maximum bandwidth supported by the user device may be 5 MHz for an NR Release 18 RedCap device, or 20 MHz for an NR Release 17 RedCap device. However, it should be noted that the maximum bandwidth supported by the user device may also be a different value than 5 MHz or 20 MHz.

In another example, the term “bandwidth” may refer to the bandwidth part (BWP) supported by the user device, for example, bandwidth part configured for RedCap devices (i.e., a RedCap-specific BWP). The BWP may be uplink or downlink BWP.

In another example, the term “bandwidth” may refer to the bandwidth supported by the user device, comprising a RedCap-specific search space configuration or RedCap-specific paging early indication search space.

In block 202, a message is transmitted to the user device based on the bandwidth supported by the user device. For example, the message may be transmitted on a bandwidth smaller than or equal to the bandwidth supported by the user device. As another example, the message may be transmitted on a BWP smaller than or equal to the bandwidth supported by the user device, and the BWP may be a RedCap-specific BWP. For example, the message may be transmitted on a bandwidth/BWP comprising a RedCap-specific search space configuration or a bandwidth/BWP comprising a RedCap-specific paging early indication search space. The message may comprise, for example, one of: a paging message, a paging early indication, a wake-up signal, or a short message.

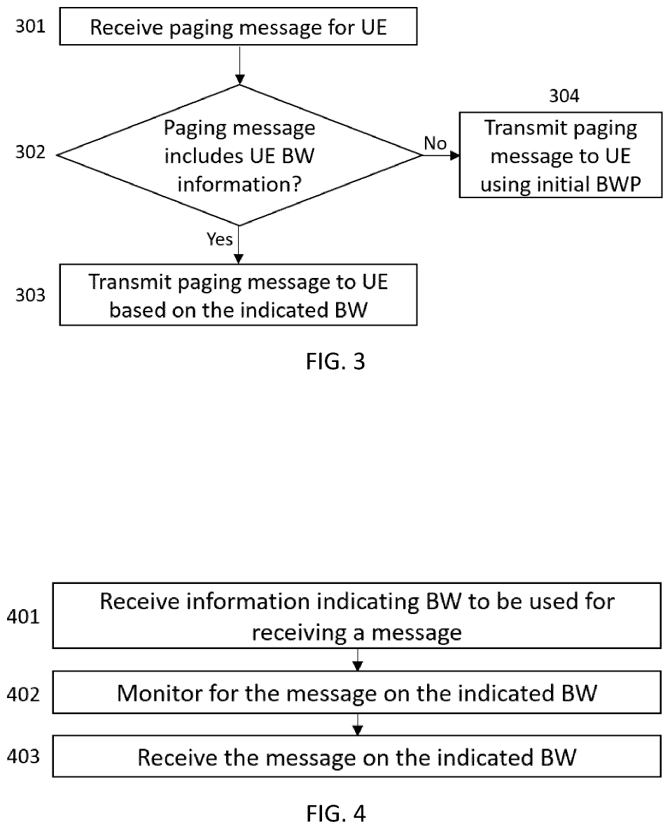

FIG. 3 illustrates a flow chart according to another example embodiment of a method performed by an apparatus such as, or comprising, or comprised in, an access node of a radio access network. The access node may correspond to the access node 104 of FIG. 1.

Referring to FIG. 3, in block 301, a paging message for a user device is received. The paging message may be received, for example, from another access node, or from a core network entity such as an access and mobility management function (AMF).

In block 302, it is determined whether the received paging message comprises information indicating a bandwidth supported by the user device. The indicated bandwidth may be smaller than or equal to a maximum bandwidth supported by the user device.

In block 303, if the received paging message comprises the information indicating the bandwidth supported by the user device (302: yes), then a paging message is transmitted to the user device based on the bandwidth supported by the user device. For example, the paging message may be transmitted on a bandwidth smaller than or equal to the bandwidth supported by the user device.

Alternatively, in block 304, if the received paging does not comprise the information indicating the bandwidth supported by the user device (302: no), then the paging message is transmitted to the user device using an initial bandwidth part (BWP) supported by all user devices. In this case, the user device may be a legacy NR UE, for example. RedCap devices and bandwidth-limited user devices may miss the paging opportunities in this case.

FIG. 4 illustrates a flow chart according to an example embodiment of a method performed by an apparatus such as, or comprising, or comprised in, a user device. The user device may also be called a subscriber unit, mobile station, remote terminal, access terminal, user terminal, terminal device, or user equipment (UE). The user device may correspond to one of the user devices 100, 102 of FIG. 1. The user device may be a reduced capability device or any other type of user device.

Referring to FIG. 4, in block 401, information indicating a bandwidth to be used for receiving a message is received. The bandwidth may be indicated as a value. The bandwidth to be used for receiving the message may be smaller than or equal to a maximum bandwidth supported by the apparatus. The information may be received, for example, from an access node or a core network entity such as an access and mobility management function (AMF).

In block 402, the apparatus monitors for the message on the indicated bandwidth.

In block 403, the message is received on the indicated bandwidth during the monitoring. The received message may comprise, for example, one of: a paging message, a paging early indication, a wake-up signal, or a short message.

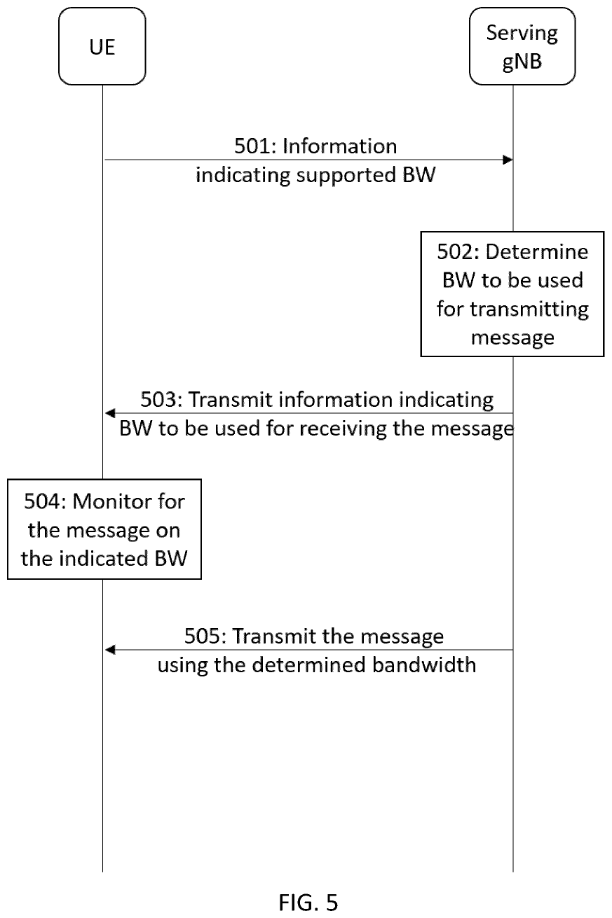

FIG. 5 illustrates a signaling diagram according to an example embodiment.

Referring to FIG. 5, a user device transmits 501 information to an access node such as a gNB, wherein the information indicates at least a bandwidth supported by the user device. Alternatively, the access node may obtain the information from some other source, for example from another access node or from an AMF. The user device may be a reduced capability device or any other type of user device.

The access node determines 502, based on the information indicating the bandwidth supported by the user device, a bandwidth to be used for transmitting a message to the user device. In this case, the access node knows the capabilities of the user device, including the bandwidth supported by the user device.

The access node transmits 503 with broadcast and/or dedicated signaling, to the user device, information indicating the determined bandwidth to be used by the user device for receiving the message. The access node may transmit this information to the user device for example in system information and/or dedicated RRC signaling. The bandwidth to be used for receiving the message is based on the bandwidth supported by the user device. For example, the bandwidth to be used for receiving the message may be smaller than or equal to the bandwidth supported by the user device.

The user device monitors 504 for the message on the bandwidth indicated by the access node.

The access node transmits 505, to the user device, the message using the determined bandwidth (i.e., the bandwidth to be used by the user device for receiving the message). The user device receives the message during the monitoring on the bandwidth indicated by the serving gNB. The message may comprise, for example, one of: a paging message, a paging early indication, a wake-up signal, or a short message.

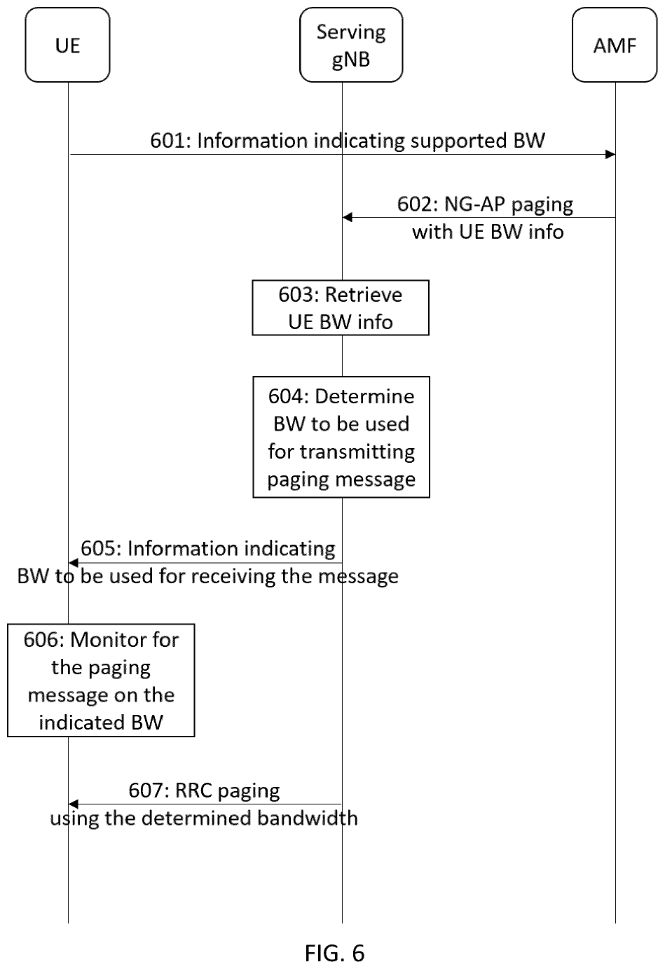

FIG. 6 illustrates a signaling diagram according to another example embodiment.

Referring to FIG. 6, a user device transmits 601 information to an AMF via non-access stratum (NAS) signaling, for example in registration procedure, wherein the information indicates at least a bandwidth supported by the user device. Alternatively, the information may be provided to the AMF by a gNB. The user device may be a reduced capability device or any other type of user device. As a non-limiting example, the user device may be an NR Release 18 RedCap device with a maximum supported bandwidth of 5 MHZ.

The AMF transmits 602 an NG-AP paging message for the user device to the serving gNB (access node), wherein the NG-AP paging message comprises the information indicating the bandwidth supported by the user device. This information may be provided as an additional information element (IE) in the NG-AP paging message.

The serving gNB retrieves 603 the information indicating the bandwidth supported by the user device from the NG-AP paging message.

The serving gNB determines 604, based on the information indicating the bandwidth supported by the user device, a bandwidth to be used for transmitting an RRC paging message to the user device. In other words, when a paging message for the user device is received by the serving gNB from the core network (e.g., AMF), the serving gNB determines the bandwidth to be used for paging based on the bandwidth information received from the AMF. The determined bandwidth may be smaller than or equal to the bandwidth supported by the user device.

The serving gNB transmits 605 with broadcast and/or dedicated signaling, to the user device, information indicating the determined bandwidth to be used by the user device for receiving the RRC paging message. The serving gNB may transmit this information to the user device for example in system information and/or dedicated RRC signaling.

The user device monitors 606 for the RRC paging message on the bandwidth indicated by the serving gNB. The user device may be pre-configured with a bandwidth-limited paging configuration for the paging monitoring.

The serving gNB transmits 607, to the user device in RRC idle or inactive state, the RRC paging message using the determined bandwidth. The user device receives the RRC paging message during the monitoring on the bandwidth indicated by the serving gNB.

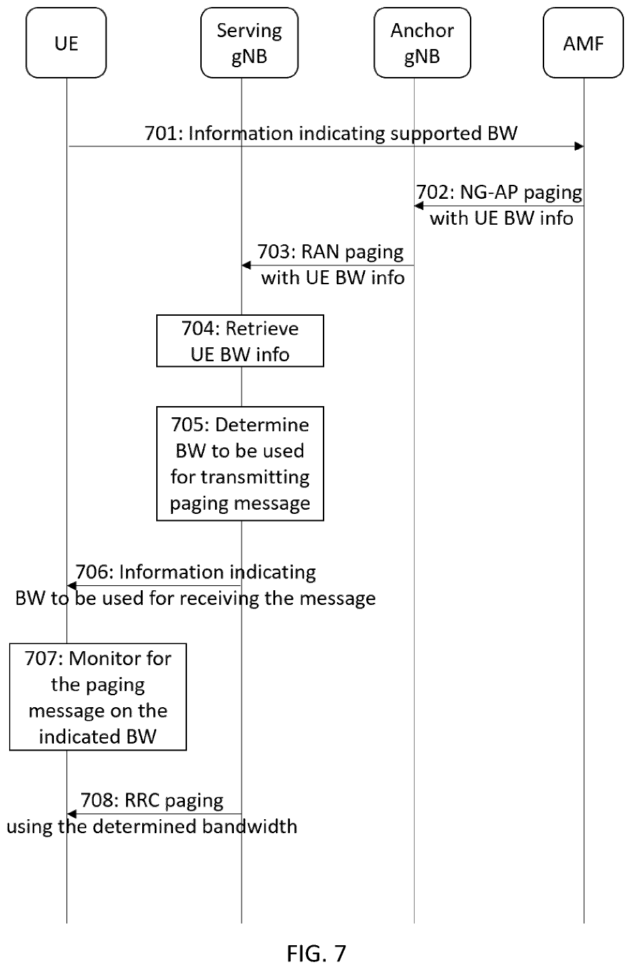

FIG. 7 illustrates a signaling diagram according to another example embodiment.

Referring to FIG. 7, a user device transmits 701 information to an AMF via non-access stratum (NAS) signaling, for example in registration procedure, wherein the information indicates at least a bandwidth supported by the user device. Alternatively, the information may be provided to the AMF by a gNB. The user device may be a reduced capability device or any other type of user device. As a non-limiting example, the user device may be an NR Release 18 RedCap device with a maximum supported bandwidth of 5 MHz.

The AMF transmits 702 an NG-AP paging message for the user device to an anchor gNB, wherein the NG-AP paging message comprises the information indicating the bandwidth supported by the user device. This information may be provided as an additional information element (IE) in the NG-AP paging message. Herein the term “anchor gNB” refers to the last serving gNB of the user device that is known by the core network, and where the AMF will firstly page the user device.

The anchor gNB transmits 703 a RAN paging message to the serving gNB of the user device, wherein the RAN paging message comprises the information indicating the bandwidth supported by the user device. This information may be provided as an additional IE in the RAN paging message.

The serving gNB retrieves 704 the information indicating the bandwidth supported by the user device from the RAN paging message.

The serving gNB determines 705, based on the information indicating the bandwidth supported by the user device, a bandwidth to be used for transmitting an RRC paging message to the user device. The determined bandwidth may be smaller than or equal to the bandwidth supported by the user device.

The serving gNB transmits 706 with broadcast and/or dedicated signaling, to the user device, information indicating the determined bandwidth to be used by the user device for receiving the RRC paging message. The access node may transmit this information to the user device for example in system information and/or dedicated RRC signaling.

The user device monitors 707 for the RRC paging message on the bandwidth indicated by the serving gNB. The user device may be pre-configured with a bandwidth-limited paging configuration for the paging monitoring.

The serving gNB transmits 708, to the user device in RRC idle or inactive state, the RRC paging message using the determined bandwidth (i.e., the bandwidth or the bandwidth part to be used by the user device for receiving the RRC paging message). The user device receives the RRC paging message during the monitoring on the bandwidth indicated by the serving gNB.

Table 1 below presents an example of the contents of the NG-AP paging message. The purpose of the NG-AP paging procedure is to enable the AMF to page the user device in the specific NG-RAN node. The AMF initiates the paging procedure by sending the paging message to the NG-RAN node (i.e., gNB). At the reception of the paging message, the NG-RAN node shall perform paging of the user device in cells, which belong to tracking areas as indicated in the tracking area identity (TAI) List for Paging IE. In Table 1, the UE BW information IE comprises the information indicating the bandwidth supported by the user device.

TABLE 1

| | | | IE type | | | |
|---|---|---|---|---|---|---|
| IE/Group | | | and | Semantics | | Assigned |
| Name | Presence | Range | reference | description | Criticality | Criticality |
| Message Type | M | | 9.3.1.1 | | YES | ignore |
| UE Paging | M | | 9.3.3.18 | | YES | ignore |
| Identity | | | | | | |
| Paging DRX | O | | 9.3.1.90 | | YES | ignore |
| TAI List for | | 1 | | | YES | ignore |
| Paging | | | | | | |
| >TAI List for | | 1 . . . | | | — | |
| Paging Item | | <maxnoofTAIforPaging> | | | | |
| >>TAI | M | | 9.3.3.11 | | — | |
| Paging Priority | O | | 9.3.1.78 | | YES | ignore |
| UE Radio | O | | 9.3.1.68 | | YES | ignore |
| Capability for | | | | | | |
| Paging | | | | | | |
| Paging Origin | O | | 9.3.3.22 | | YES | ignore |
| Assistance Data | O | | 9.3.1.69 | | YES | ignore |
| for Paging | | | | | | |
| NB-IoT Paging | O | | 9.3.1.138 | | YES | ignore |
| eDRX | | | | | | |
| Information | | | | | | |
| NB-IoT Paging | O | | 9.3.1.139 | If this IE is | YES | ignore |
| DRX | | | | present, | | |
| | | | | the Paging | | |
| | | | | DRX IE is | | |
| | | | | ignored. | | |
| Enhanced | O | | 9.3.1.140 | | YES | ignore |
| Coverage | | | | | | |
| Restriction | | | | | | |
| WUS Assistance | O | | 9.3.1.143 | | YES | ignore |
| Information | | | | | | |
| E-UTRA Paging | O | | 9.3.1.154 | | YES | ignore |
| eDRX | | | | | | |
| Information | | | | | | |
| CE-mode-B | O | | 9.3.1.155 | | YES | ignore |
| Restricted | | | | | | |
| NR Paging | O | | 9.3.1.227 | | YES | ignore |
| eDRX | | | | | | |
| Information | | | | | | |
| Paging Cause | O | | ENUMERATED | | YES | ignore |
| | | | (voice, . . .) | | | |
| PEIPS | O | | 9.3.1.232 | | YES | ignore |
| Assistance | | | | | | |
| Information | | | | | | |
| UE BW | O | | ENUMERATED | | YES | |
| information | | | (5, 20, . . .) | | | |

Table 2 below presents an example of the contents of the RAN paging message. The purpose of the RAN paging procedure is to enable NG-RAN node1 (e.g., the anchor gNB) to request paging of a user device in the NG-RAN node2 (e.g., the serving gNB of the user device). In Table 2, the UE BW information IE comprises the information indicating the bandwidth supported by the user device.

TABLE 2

| | | | | | | |
|---|---|---|---|---|---|---|
| | | | IE type | | | |
| IE/Group | | | and | Semantics | | Assigned |
| Name | Presence | Range | reference | description | Criticality | Criticality |

| | | | | | |
|---|---|---|---|---|---|
| Message Type | M | 9.2.3.1 | | YES | reject |
| CHOICE UE | M | | | YES | reject |
| Identity Index | | | | | |
| Value | | | | | |
| >Length-10 | | | | | |
| >>Index | M | BIT | Coded as | — | |
| Length-10 | | STRING | specified in | | |
| | | (SIZE(10)) | TS 38.304 | | |
| | | | and TS | | |
| | | | 36.304. | | |
| UE RAN Paging | M | 9.2.3.43 | | YES | ignore |
| Identity | | | | | |
| Paging DRX | M | 9.2.3.66 | Includes | YES | ignore |
| | | | the RAN | | |
| | | | paging | | |
| | | | cycle as | | |
| | | | defined in | | |
| | | | TS 36.304 | | |
| | | | and 38.304. | | |
| RAN Paging | M | 9.2.3.38 | | YES | reject |
| Area | | | | | |
| Paging Priority | O | 9.2.3.44 | | YES | ignore |
| Assistance Data | O | 9.2.3.41 | | YES | ignore |
| for RAN Paging | | | | | |
| UE Radio | O | 9.2.3.91 | | YES | ignore |
| Capability for | | | | | |
| Paging | | | | | |
| Extended UE | O | 9.2.3.141 | Coded as | YES | ignore |
| Identity Index | | | specified in | | |
| Value | | | TS 36.304. | | |
| E-UTRA Paging | O | 9.2.3.142 | | YES | ignore |
| eDRX | | | | | |
| Information | | | | | |
| UE specific DRX | O | 9.2.3.143 | Includes | YES | ignore |
| | | | the UE | | |
| | | | specific | | |
| | | | paging | | |
| | | | cycle as | | |
| | | | defined in | | |
| | | | TS 36.304 | | |
| | | | and 38.304. | | |
| NR Paging eDRX | O | 9.2.3.161 | | YES | ignore |
| Information | | | | | |
| NR Paging eDRX | O | 9.2.3.162 | | YES | ignore |
| Information for | | | | | |
| RRC INACTIVE | | | | | |
| Paging Cause | O | ENUMERATED | | YES | ignore |
| | | (voice, . . .) | | | |
| PEIPS | O | 9.2.3.166 | | YES | ignore |
| Assistance | | | | | |
| Information | | | | | |
| UE BW | O | ENUMERATED | | YES | |
| information | | (5, 20, . . .) | | | |

The blocks, related functions, and information exchanges (messages) described above by means of FIGS. 2-6 are in no absolute chronological order, and some of them may be performed simultaneously or in an order differing from the described one. Other functions can also be executed between them or within them, and other information may be sent, and/or other rules applied. Some of the blocks or part of the blocks or one or more pieces of information can also be left out or replaced by a corresponding block or part of the block or one or more pieces of information.

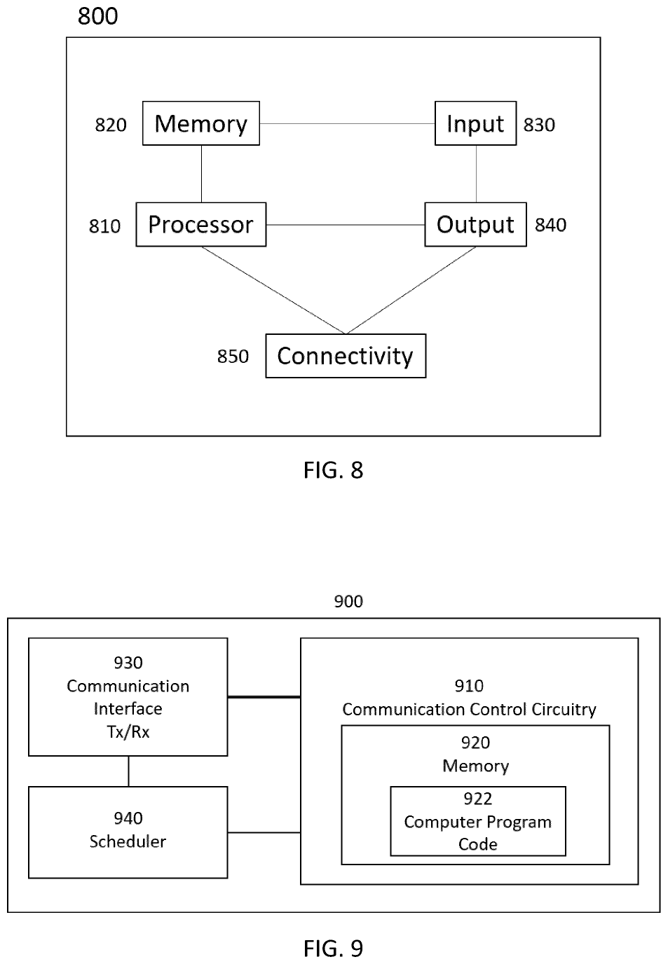

FIG. 8 illustrates an example embodiment of an apparatus 800, which may be an apparatus such as, or comprising, or comprised in, a user device. The user device may correspond to one of the user devices 100, 102 of FIG. 1. The user device may also be called a subscriber unit, mobile station, remote terminal, access terminal, user terminal, terminal device, or user equipment (UE).

The apparatus 800 comprises at least one processor 810. The at least one processor 810 interprets computer program instructions and processes data. The at least one processor 810 may comprise one or more programmable processors. The at least one processor 810 may comprise programmable hardware with embedded firmware and may, alternatively or additionally, comprise one or more application-specific integrated circuits (ASICs).

The at least one processor 810 is coupled to at least one memory 820. The at least one processor is configured to read and write data to and from the at least one memory 820. The at least one memory 820 may comprise one or more memory units. The memory units may be volatile or non-volatile. It is to be noted that in some example embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The at least one memory 820 stores computer readable instructions that are executed by the at least one processor 810 to perform one or more of the example embodiments described above. For example, non-volatile memory stores the computer readable instructions, and the at least one processor 810 executes the instructions using volatile memory for temporary storage of data and/or instructions.

The computer readable instructions may have been pre-stored to the at least one memory 820 or, alternatively or additionally, they may be received, by the apparatus, via an electromagnetic carrier signal and/or may be copied from a physical entity such as a computer program product. Execution of the computer readable instructions causes the apparatus 800 to perform one or more of the functionalities described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer.

The apparatus 800 may further comprise, or be connected to, an input unit 830. The input unit 830 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 830 may comprise an interface to which external devices may connect to.

The apparatus 800 may also comprise an output unit 840. The output unit may comprise or be connected to one or more displays capable of rendering visual content, such as a light emitting diode (LED) display, a liquid crystal display (LCD) and/or a liquid crystal on silicon (LCoS) display. The output unit 840 may further comprise one or more audio outputs. The one or more audio outputs may be for example loudspeakers.

The apparatus 800 further comprises a connectivity unit 850. The connectivity unit 850 enables wireless connectivity to one or more external devices. The connectivity unit 850 comprises at least one transmitter and at least one receiver that may be integrated to the apparatus 800 or that the apparatus 800 may be connected to. The at least one transmitter comprises at least one transmission antenna, and the at least one receiver comprises at least one receiving antenna. The connectivity unit 850 may comprise an integrated circuit or a set of integrated circuits that provide the wireless communication capability for the apparatus 800. Alternatively, the wireless connectivity may be a hardwired application-specific integrated circuit (ASIC). The connectivity unit 850 may comprise one or more components, such as: power amplifier, digital front end (DFE), analog-to-digital converter (ADC), digital-to-analog converter (DAC), frequency converter, (de) modulator, and/or encoder/decoder circuitries, controlled by the corresponding controlling units.

It is to be noted that the apparatus 800 may further comprise various components not illustrated in FIG. 8. The various components may be hardware components and/or software components.

The apparatus 900 of FIG. 9 illustrates an example embodiment of an apparatus such as, or comprising, or comprised in, an access node of a radio access network. The access node may correspond to the access node 104 of FIG. 1. The apparatus 900 may also be referred to, for example, as a network node, a network element, a radio access network (RAN) node, a next generation radio access network (NG-RAN) node, a NodeB, an eNB, a gNB, a base transceiver station (BTS), a base station, an NR base station, a 5G base station, an access node, an access point (AP), a relay node, a repeater, an integrated access and backhaul (IAB) node, an IAB donor node, a distributed unit (DU), a central unit (CU), a baseband unit (BBU), a radio unit (RU), a radio head, a remote radio head (RRH), or a transmission and reception point (TRP).

The apparatus 900 may comprise, for example, a circuitry or a chipset applicable for realizing one or more of the example embodiments described above. The apparatus 900 may be an electronic device comprising one or more electronic circuitries. The apparatus 900 may comprise a communication control circuitry 910 such as at least one processor, and at least one memory 920 storing instructions which, when executed by the at least one processor, cause the apparatus 900 to carry out one or more of the example embodiments described above. Such instructions may, for example, include a computer program code (software) 922 wherein the at least one memory and the computer program code (software) 922 are configured, with the at least one processor, to cause the apparatus 900 to carry out some of the example embodiments described above. Herein computer program code may in turn refer to instructions that cause the apparatus 900 to perform one or more of the example embodiments described above. That is, the at least one processor and the at least one memory 920 storing the instructions may cause said performance of the apparatus.

The processor is coupled to the memory 920. The processor is configured to read and write data to and from the memory 920. The memory 920 may comprise one or more memory units. The memory units may be volatile or non-volatile. It is to be noted that in some example embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 920 stores computer readable instructions that are executed by the processor. For example, non-volatile memory stores the computer readable instructions and the processor executes the instructions using volatile memory for temporary storage of data and/or instructions.

The computer readable instructions may have been pre-stored to the memory 920 or, alternatively or additionally, they may be received, by the apparatus, via an electromagnetic carrier signal and/or may be copied from a physical entity such as a computer program product. Execution of the computer readable instructions causes the apparatus 900 to perform one or more of the functionalities described above.

The memory 920 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data. For example, the configuration database may store a current neighbour cell list, and, in some example embodiments, structures of the frames used in the detected neighbour cells.

The apparatus 900 may further comprise a communication interface 930 comprising hardware and/or software for realizing communication connectivity according to one or more communication protocols. The communication interface 930 comprises at least one transmitter (Tx) and at least one receiver (Rx) that may be integrated to the apparatus 900 or that the apparatus 900 may be connected to. The communication interface 930 may comprise one or more components, such as: power amplifier, digital front end (DFE), analog-to-digital converter (ADC), digital-to-analog converter (DAC), frequency converter, (de) modulator, and/or encoder/decoder circuitries, controlled by the corresponding controlling units.

The communication interface 930 provides the apparatus with radio communication capabilities to communicate in the cellular communication system. The communication interface may, for example, provide a radio interface to one or more user devices. The apparatus 900 may further comprise another interface towards a core network such as the network coordinator apparatus and/or to the access nodes of the cellular communication system.

The apparatus 900 may further comprise a scheduler 940 that is configured to allocate radio resources. The scheduler 940 may be configured along with the communication control circuitry 910 or it may be separately configured.

It is to be noted that the apparatus 900 may further comprise various components not illustrated in FIG. 9. The various components may be hardware components and/or software components.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s), software, and memory (ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the example embodiments described above, but may vary within the scope of the claims. Therefore, all words and expressions should be interpreted broadly, and they are intended to illustrate, not to restrict, the example embodiments.

1. An apparatus comprising at least one processor, and at least one memory including computer program code, wherein the at least one memory and the computer program code are configured, with the at least one processor, to cause the apparatus to:
receive information indicating a bandwidth supported by a user device; and
transmit, to the user device, a message based on the bandwidth supported by the user device.

2. The apparatus according to claim 1, further being caused to:
transmit, to the user device, information indicating a bandwidth to be used for receiving the message.

3. The apparatus according to claim 1, wherein the indicated bandwidth supported by the user device is smaller than or equal to a maximum bandwidth supported by the user device.

4. The apparatus according to claim 1, wherein the message comprises one of: a paging message, a paging early indication, a wake-up signal, or a short message.

5. The apparatus according to claim 1, wherein the user device is a reduced capability device.

6. The apparatus according to claim 1, further being caused to:
determine, based on the information indicating the bandwidth supported by the user device, a bandwidth to be used for transmitting the message.

7. The apparatus according to claim 1, wherein the apparatus comprises, or is comprised in, an access node.

8. The apparatus according to claim 7, wherein the information indicating the bandwidth supported by the user device is received from another access node.

9. The apparatus according to claim 1, further being caused to:
receive, from an access and mobility management function, a paging message for the user device, the paging message comprising the information indicating the bandwidth supported by the user device.

10. An apparatus comprising at least one processor, and at least one memory including computer program code, wherein the at least one memory and the computer program code are configured, with the at least one processor, to cause the apparatus to:
receive information indicating a bandwidth to be used for receiving a message;
monitor for the message on the indicated bandwidth; and
receive the message on the indicated bandwidth during the monitoring.

11. The apparatus according to claim 10, wherein the bandwidth to be used for receiving the message is smaller than or equal to a maximum bandwidth supported by the apparatus.

12. The apparatus according to claim 10, further being caused to:
transmit information indicating a bandwidth supported by the apparatus, wherein the bandwidth to be used for receiving the message is based on the bandwidth supported by the apparatus.

13. The apparatus according to claim 12, wherein the information is transmitted to an access and mobility management function via non-access stratum signaling.

14. The apparatus according to claim 10, wherein the message comprises one of: a paging message, a paging early indication, a wake-up signal, or a short message.

15. The apparatus according to claim 10, wherein the apparatus comprises, or is comprised in, a user device.

16. The apparatus according to claim 15, wherein the user device is a reduced capability device.

17-18. (canceled)

19. A method comprising:
receiving information indicating a bandwidth supported by a user device; and
transmitting, to the user device, a message based on the bandwidth supported by the user device.

20-22. (canceled)
